(19) United States
(12) Patent Application Publication
(10) Pub. No.: US 2007/0033430 A1
(43) Pub. Date: Feb. 8, 2007

(54) Data storage distribution and retrieval

(76) Inventors: Gene Itkis, Newton, MA (US); William J. Oliver, Lexington, MA (US); Joseph Boykin, Wayland, MA (US)

Correspondence Address: HAYES, SOLOWAY P.C., 175 CANAL STREET, MANCHESTER, NH, 03101, US

(21) Appl. No.: 10/555,878

(22) PCT Filed: May 5, 2004
(86) PCT No.: PCT/US04/13985

§ 371 Date: Aug. 14, 2006

Related U.S. Application Data
(60) Provisional application No. 60/467,909, filed on May 5, 2003.

(51) Int. Cl. G06F 11/00

(52) U.S. Cl. 714/6

(57) ABSTRACT

A device and method for storing data is disclosed. A user record is divided up into a plurality of input packets (block 202). The plurality of input packets is encoded into a plurality of output packets (block 204). The output packets are distributed to one or more storage devices (block 206). The user record is reconstructed by retrieving the plurality of output packets from the storage devices (block 1002) and deconstructing output packets into one or more input packets (block 1004). The input packets are evaluated to determine which additional output packets are required to complete the user record (block 1006). The process of retrieving the output packets and deconstructing the output packets into one or more input packets is repeated until the user record is complete (block 1008).

### CROSS-REFERENCE TO RELATED APPLICATION

This application claims priority to co-pending U.S. Provisional Application entitled, “Robust Data Storage Distribution and Retrieval System,” having Ser. No. 60/467,909, filed May 5, 2003, which is entirely incorporated herein by reference.

### FIELD OF THE INVENTION

The invention relates generally to the field of data storage systems, and particularly to a data storage distribution and retrieval system.

### BACKGROUND OF THE INVENTION

The increase in the amount of data generated by businesses and the importance of the ability of a business to retrieve the information reliably has put a greater demand on data storage systems. Information technology professionals desire a data storage system that can efficiently handle and store vast amounts of data generated by the business.

Not only should the data storage system be able to manage and store the data, it should also securely store the data. The data needs to be safe from theft or corruption and stored in a manner that provides rapid accessibility. The data storage system should also make efficient use of the information technology resources of the business and not put additional strain on the bottom line of the business.

Because every business is different, there is a need for a data storage system that can be tailored to the individual needs and objectives of the business. For example, one business may place a high demand on security, but have a large amount of data management resources. In contrast, another business may require that customers have rapid access to data with modest concerns about security. In addition, as a business grows the demand on the data storage system may change. A business in its early stages may have greater concern with the efficient use of the limited information technology resources of the business. As the business grows, the concern may shift towards more tightly securing the information. Information technology professionals require a data storage system that can be custom tailored to the changing needs of a business.

Businesses also demand a data storage system that can work concurrently with multiple data storage architectures: As a business grows, the business typically will expand its data storage system. A system purchased in the early stages of a business may be vastly different from a data storage system purchased later to handle the increased demands of data storage by the business. Businesses desire a data storage system that can make use of newly acquired, current technology data storage systems and previously purchased, older data storage systems concurrently.

Thus, a heretofore unaddressed need exists in the industry to address the aforementioned deficiencies and inadequacies.

### SUMMARY OF THE INVENTION

The invention, in one embodiment, remedies the deficiencies of the prior art by providing a system that protects against loss of a user record by dividing the information into input packets and then encoding one or more input packets into output packets. The output packets are stored on various storage devices throughout the storage infrastructure. The user record can be restored even if an output packet is lost or slow in arriving as a result of failure in storage or transmission.

In one aspect, the invention provides a method of storing data. The method includes dividing up a user record into a plurality of input packets; encoding each of the plurality of input packets into more than one of a plurality of output packets; and distributing the plurality of output packets to one or more storage devices. In one embodiment, the location of the plurality of output packets is stored in a metadata. In another embodiment, the distributing step includes striping. The distributing step may also include factoring storage device/path performance or storage device capacity into the distribution of the plurality of output packets.

In another aspect, the invention provides a method of reconstructing data. The method includes retrieving one or more output packets from one or more storage devices; deconstructing one or more of the one or more output packets to one or more input packets; evaluating which input packets are missing and which additional output packets are needed; and repeating the retrieving, deconstructing, and evaluating steps until a user record is reconstructed.

In another embodiment, the methods and system of the invention can reliably retrieve stored data even if as many as 40% of the storage devices fail to return an output packet In another embodiment, the methods and system of the invention can reliably retrieve stored data even if as many as 60% of the storage devices fail to return an output packet. In yet another embodiment, the methods and system of the invention can reliably retrieve stored data even if as many as 80% of the storage devices fail to return an output packet. In one embodiment, the one or more output packets are requested in successive waves. In another embodiment, a metadata is accessed to determine the location of the one or more output packets. The retrieving step may further include factoring in storage device performance when determining which output packets to retrieve.

In another embodiment, the invention improves capacity utilization by removing constraints found in existing solutions to the theoretical maximum. In another embodiment, the invention improves continuous availability and reduces the overhead to provide such continuous availability by enabling data recovery even after multiple devices are lost. In one embodiment, the invention improves performance (the time it takes to return data to a user). In one embodiment, the invention provides encryption level or near-encryption level security of the data.

In other embodiments, the system of the above-described embodiments can be implemented with a computer-readable media tangibly embodying a program of instructions executable by a computer. The system can also be a device with hardware modules constructed to perform the above-described embodiments.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 depicts the components and functions of a data storage distribution and retrieval system, according to an illustrative embodiment of the invention.

FIG. 2 is a flow chart illustrating the method of storing data, according to an illustrative embodiment of the invention.

FIG. 3 is a schematic diagram illustrating the components produced by the data storage distribution and retrieval system, according to an illustrative embodiment of the method for storing.

FIG. 4 is a schematic diagram illustrating the components produced by the data storage distribution and retrieval system, according to an alternative illustrative embodiment of the invention.

FIG. 5 is a graph of an exemplary distribution of degrees, according to an illustrative embodiment of the invention.

FIG. 6 is an example of a stylized encoding chart, according to an illustrative embodiment of the invention.

FIG. 7 is an example of an encoding chart of a user record displaying the components produced by the system, according to an illustrative embodiment of the invention.

FIG. 8 is a graph illustrating the effect of a change in the degree and an expansion factor, according to an illustrative embodiment of the invention.

FIG. 9 is a flow chart illustrating the method of storing data, according to an illustrative alternate embodiment of the method for storing.

FIG. 10 is a flow chart illustrating the method of retrieving data, according to an illustrative embodiment of the method for retrieving.

FIG. 11 is a flow chart illustrating the method of retrieving data, according to an illustrative alternate embodiment of the method for retrieving.

### DETAILED DESCRIPTION

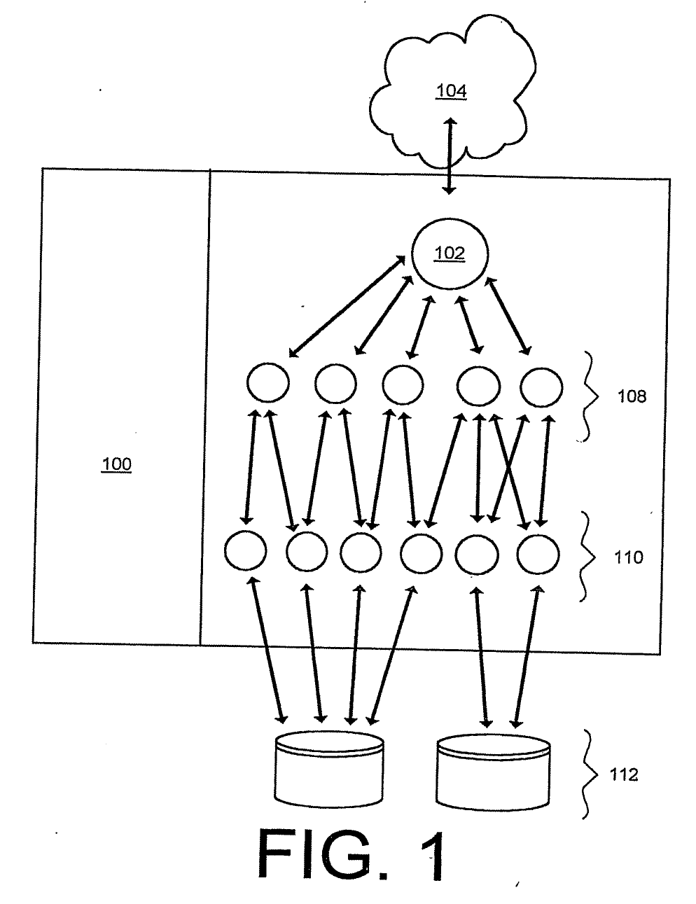

FIG. 1 depicts an overview of a data storage distribution and retrieval system 100 according to a first exemplary embodiment of the invention. A user record 102 is requested or received by the system 100 from a device that provides or requests data 104. The data-providing or requesting device 104 can be any number of devices, for example but not limited to, a workstation, a server, a data sampling device, a Local Area Network (LAN), a Wide Area Network (WAN), or a data storage device. When the system 100 receives a user record 102 that is destined for storage, the system 100 prepares the user record 102 for storage. The system 100 splits the user record 102 into input packets 108, which are encoded into output packets 110 by the system 100. These output packets 110 are stored within one or more storage devices 112 by the system 100.

When the system 100 receives a request for the stored user record 102, the output packets 110 are retrieved from the storage devices 112 and decoded into input packets 108. The input packets 108 are assembled to produce the user record 102. The system 100 provides a data storage system that balances between security, data recovery, processing time, and management of system resources. The system 100 allows for real-time management of multiple storage devices and management of heterogeneous storage devices, as will be discussed later.

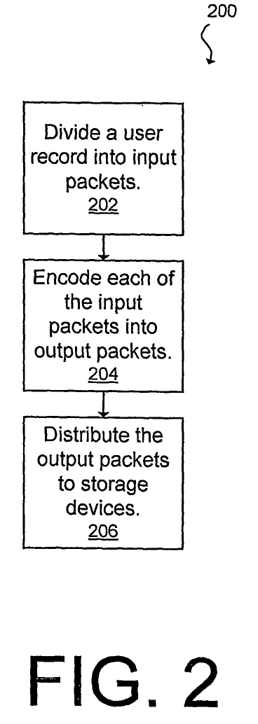

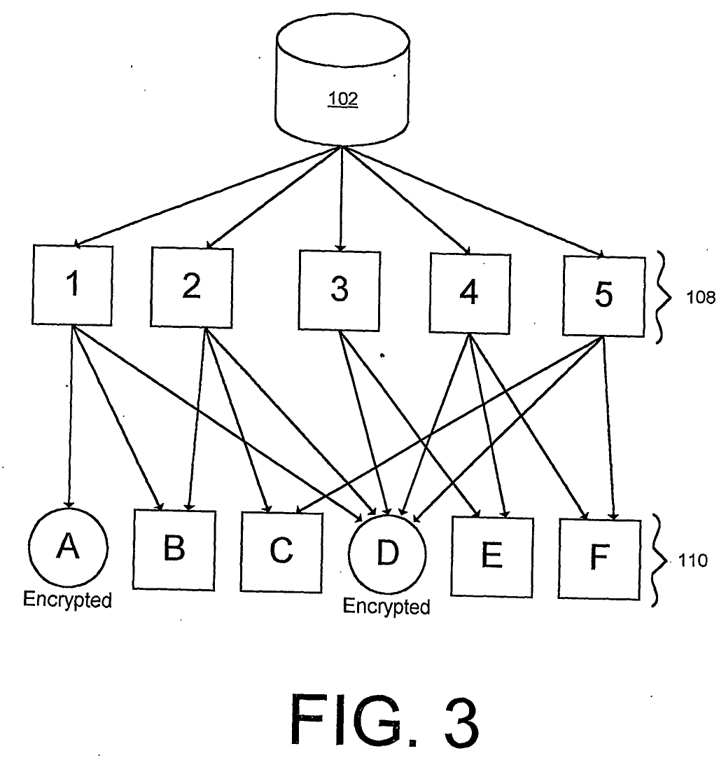

The flowchart of FIG. 2 depicts an exemplary method for storing data 200. FIG. 3 is an illustrative diagram of the stages of the data storage 300 as the user record 102 is divided into input packets 108 and encoded into output packets 110. The method divides the user record 102 into a plurality of input packets 108 (block 202).

The size and number of input packets 108 into which the user record 102 is divided can be determined for each user record 102. For example, the following algorithm may be used: IPₙ=round (U/IPₜ) and IP=U/IPₙ, where IPₙ is the number of input packets 108, U is the size of the user record 102, IPₜ is the target size of the input packets 108, and IP is the actual size of the input packets 108. OPₜ is the target size of the output packets 110, which may be the same as IPₜ. The size of the input packets 108 and output packets 110 may be any size that an implementation of this algorithm or a similar algorithm produces.

The exemplary user record 102 of FIG. 3 is divided into five input packets 108 (i.e., input packets 1, 2, 3, 4, and 5). The five input packets 108 are encoded into six output packets 110 (i.e., output packets A, B, C, D, E, and F). It should be noted that FIG. 3 provides a simplified illustration for illustrative purposes. Accordingly, a user record 102 may be divided into many more input packets 108, which may be encoded into many more output packets 110. Increasing the number of input packets 108 increases the ability of the system 100 to increase the complexity of encoding; however, increasing the number of input packets 108 likewise will increase the demand on the processing resources of the system 100 (e.g. processor, memory, local bus).

The number of output packets 110 is determined using an expansion factor. The expansion factor represents the ratio of the sum of the sizes of the output packets 110 to the size of the user record 102. For example, a user record 102 of ten gigabits with an expansion factor of two would require storage for output packets 110 summing to twenty gigabits. As the expansion factor increases, both the availability of input packets 108 and, likewise, the performance of the system 100 will also generally increase. However, as the expansion factor increases the amount of storage space required will also increase. The expansion factor should be large enough to have at least one more output packet 110 than the number of input packets 108. Algorithmically, the expansion factor may have a very high value, but according to the illustrative embodiment, a maximum upper bound of about three is used. An expansion factor of about three requires three times the size of the user record 102 to store all of the data. According to an exemplary embodiment of the invention, the expansion factor is in the range of about 1.2 to about 1.8. An expansion factor of about 1.2 generally permits a loss (i.e., a failure of a storage device to return the output packets stored within the storage device) of about one out of six storage devices, whereas an expansion factor of about 1.8 generally permits a loss of about four out of ten storage devices.

Referring back to FIG. 2, the method encodes each of the input packets 108 into output packets 110 (block 204). Each output packet 110 is the result of encoding one or more input packets 108 together so that they bear no resemblance to the input data, so that examining the output packets 110 reveals nothing about the content of the user record 102. The number of input packets 108 encoded into an output packet 110 is determined for each output packet 110 by a pseudo-random function (“Dₙ”). The value of the function Dₙ for a specific output packet 110 may be referred to as the degree of the output packet 110.

Referring back to the illustrative diagram of FIG. 3, output packets B, C, E, and F have a degree of two (i.e. two input packets 108 are encoded into one output packet 110), while output packet D has a degree of 5 (i.e. five input packets 108 are encoded into one output packet 110). Output packet A is referred as a “singleton” and contains only information from input packet 1. Singletons are significant in that they provide the key to decoding the other output packets 110. In the illustrative diagram of FIG. 3, input packet 1 can be identified from output packet A (i.e. the singleton). Using input packet 1, input packet 2 can be identified from output packet B. Similarly, input packet 5 can be identified from output packet C and input packet 4 can be identified from output packet E and so on until all input packets 108 are decoded.

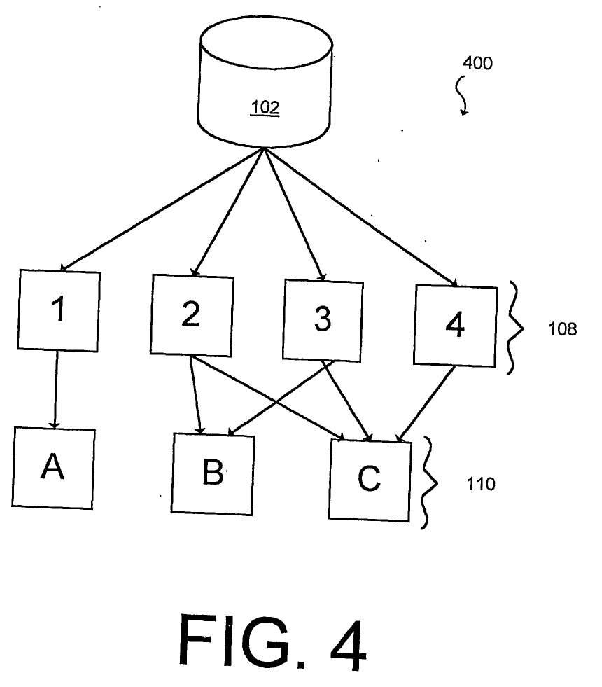

In accordance with the first exemplary embodiment, the degree of an output packet 110 is preferably one or an even number, but may be an odd number in an alternative embodiment. When the degree is one or an even number, the singletons can be used to identify the other input packets 108. In an alternative embodiment the degree can be odd, however with odd degree output packets 110 other input packets 108 may be used to decode the input packets 108 from the output packets 110. For example, in the illustrative alternative embodiment 400 shown in FIG. 4, the input packet 4 can be decoded by comparing output packet B to output packet C and identifying input packet 4. This alternative embodiment 400 would require a greater amount of encryption to ensure the security of the output packets 110.

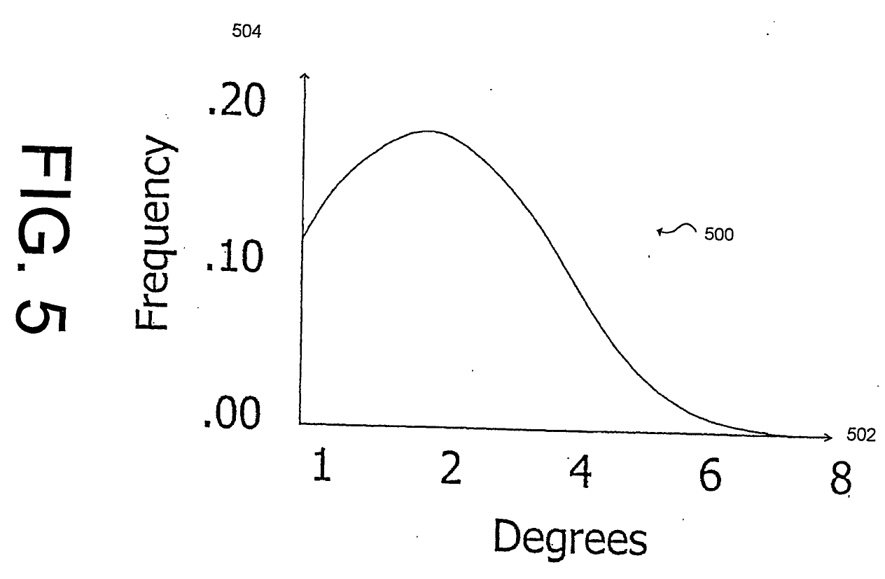

FIG. 5 depicts an illustrative exemplary distribution of the degree function 500. The abscissa 502 identifies the degree of the output packet 110 and the ordinate 504 identifies the frequency of the output packet 110. The output packets 110 with a degree of two are the most common based on this exemplary distribution of the degree function 500. This exemplary degree distribution 500 is skewed to the left to ensure that the stored output packets 110 include sufficient singletons, i.e. lower-degree output packets 110 to effectively decode the output packets 110. The increased amount of low degree output packets 110 allows for the storage device 112 of the system 100 to fail while still providing recovery of the user record 102. The increased amount of low degree output packets 110 also decreases the user record 102 recovery time by allowing the system 100 to decode multiple output packets 110 concurrently during the user record 102 retrieval process. Other distributions can be used with the system 100 to provide a variety of customized levels of security, data recovery, processing time, and management of system resources.

The system 100 can also incorporate a variety of other encoding functions when assigning the input packets 108 to output packets 110. These encoding functions can incorporate one or more of the following properties or variables.

An encoding function can be designed to ensure that there are sufficient singletons based on the number of storage devices 112 to ensure recovery of the user record 102. The encoding function can encode enough singletons such that if the number of singletons lost is less than or equal to the number of storage devices 112, the remaining singletons and output packets 110 can fully reconstruct the data. The number of storage devices 112 can be designed specific to the system 100 or can be entered by a system administrator in an end user system interface, as will be discussed later.

The encoding function can direct a singleton output packet 110 and a specific two-degree output packet 110 having the same input packet 108 as the singleton output packet 110 to separate storage devices 112 to reduce the risk of data loss. In the event that the singleton output packet 110 is lost due to a storage device 112 failure, the decoding function can identify the specific two-degree output packet 110 that also holds the same input packet 108. The system 100 can use the specific two-degree output packet 110 to obtain the lost singleton. The contents of the specific output packets 110 are chosen such that they also hold input packets identical to the singleton output packets and may be any degree of output packet. The specific output packets can be stored in such a way that if a singleton output packet is unavailable due to a storage device 112 failure or other failure, the specific output packet 110 holding a known singleton can be used to reconstruct the missing singleton.

The input packets 108 can be assigned to output packets 110 with varying degrees so as to aid in the deconstruction of the output packets 110. Allowing the singletons to decode output packets 110 with a degree of two and using the newly decoded input packets 108 to decode even higher orders of output packets 110 can improve the speed of recovery of input packets 108.

The input packets 108 can be encoded into each output packet 110 by step-wise encoding each successive input packet 108 until as many input packets 108 have been encoded as is defined by the degree specified for that output packet 110. The result is an output packet 110 that is the same size as the input packet 108. The encoding can be performed using “exclusive or,” XOR, or another suitable encoding process.

Referring back to FIG. 2, the method distributes the output packets to a storage device 112 (block 206). The system 100 can create output packets 110 suitable for a dynamic striping effect across multiple independent storage devices 112. This enhances performance in several ways. For example, the user record 102 is divided into output packets 110 that can be sent to multiple storage devices 112. This reduces data retrieval time because the physical limitations of a single storage device can often be a restrictive factor in the data retrieval process.

Additionally, output packets 110 are created with redundancy, which allows the retrieval process to reconstruct the user record 102 by choosing to use the output packets 110 that are recovered first. Accordingly, the slowest output packets 110 to return may be ignored when decoding the user record 102. This can improve upon Redundant Arrays of Independent Disks (RAID) striping, which typically requires that reconstruction of the user record 102 wait until the slowest output packet 110 is retrieved. Each encoded output packet 110 is also transformed to comply with the protocol and format specified by the storage environment. This enables the intelligent disk striping to be extended across heterogeneous storage devices 112 (i.e., different protocols and formats of storage devices). Typically the protocol and format of storage devices 112 may be, but are not limited to, SAN, NAS, iSCSI (internet Small Computer Systems Interface), InfiniBand, Serial ATA, Fibre Channel and SCSI. The system 100 does not require all of the storage devices to be of the same make or design (i.e., homogenous). The system 100 allows users to mix storage devices of different protocols and formats (i.e., heterogeneous).

The system 100 can remove the protocol information from the user record 102. The output packets 110 may be transformed as necessary to present them to the storage network (or devices 112) in a manner that conforms to the specified protocol of the storage network (or devices 112). The output packets 110 are transformed, as appropriate, to the protocol required by the target device and distribution network. The location of the output packets 110 is recorded in the metadata, and then the output packets 110 are released to the storage infrastructure for delivery as addressed. The system 100 can store metadata suitable to decode and decrypt the stored output packets 110 in local memory or in the storage device 112.

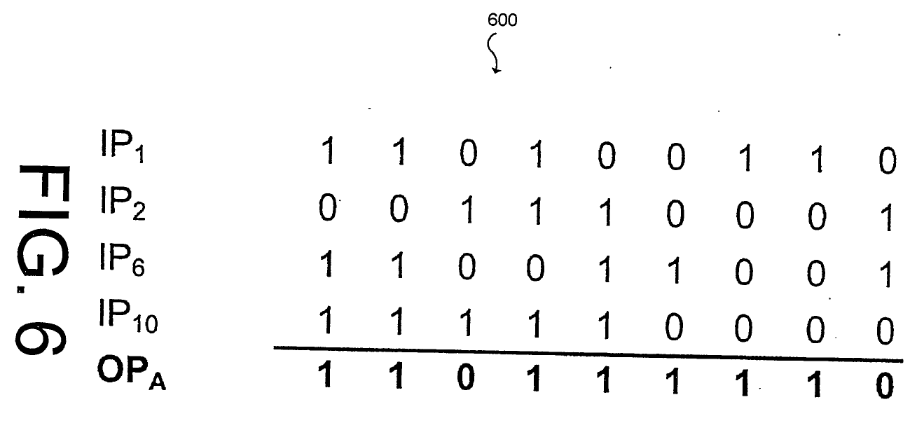

FIG. 6 depicts a stylized encoding 600 example for an output packet OP_{A} that includes four input packets IP₁, IP₂, IP₆, and IP₁₀. The OP_{A} lacks any even pattern of its underlying input packets 108, even if the input packets 108 are identical. If the input packets 108 contain all zeros, the system 100 modifies its encoding process. In this form of encoding, combined with encryption of at least 4% of the output packets (or more, if a user record 102 is divided into a smaller number of input packets 108), the system 100 provides a level of security similar to that of common full encryption processes, as will be discussed later herein.

Disk striping allows the data to be collected from multiple storage devices 112, multiplying the maximum retrieval rate. By distributing the data in this manner, disk striping spreads data across several independent storage devices 112 to achieve their combined retrieval time. Data managers may “over allocate” the data environment to overcome the low device utilization of current storage systems. In addition, a more robust fault tolerance is achieved by intelligently spreading the output packets 110 (each containing redundant copies of the user data) across independent storage devices 112. Therefore, the system 100 can reconstruct data even if, for example, 4 of 10 devices fail. In contrast, (RAID) 5, for example, can lose only one drive. The level of fault tolerance, therefore, may be adjusted by altering how many redundant copies of each input packet 108 are encoded into various output packets 110, and over how many storage devices 112 the output packets 110 are distributed.

For storage devices 112 that send data to predetermined devices or partitions, the process achieves high device performance by loading data in large packets contiguously stored on pre-allocated space (in fixed allocations) in a storage device 112. This system is used to obtain maximum write and read efficiency. Using output packets 110 encoded by this process, pre-allocating space is no longer optimal or desirable. The system 100 can spread the output packets 110 widely throughout the storage environment. Performance that may be lost to smaller, non-contiguous write packets is regained through the impact of disk striping. Furthermore, the system 100 permits users to establish virtual storage allocations, which have no real impact on physical storage. Actual storage space is allocated only at the time of a write operation. This allows the system administrator to use each storage device 112 to its actual capacity. Using the system of the invention, the system administrator need not waste storage capacity by pre-allocating to a specific user.

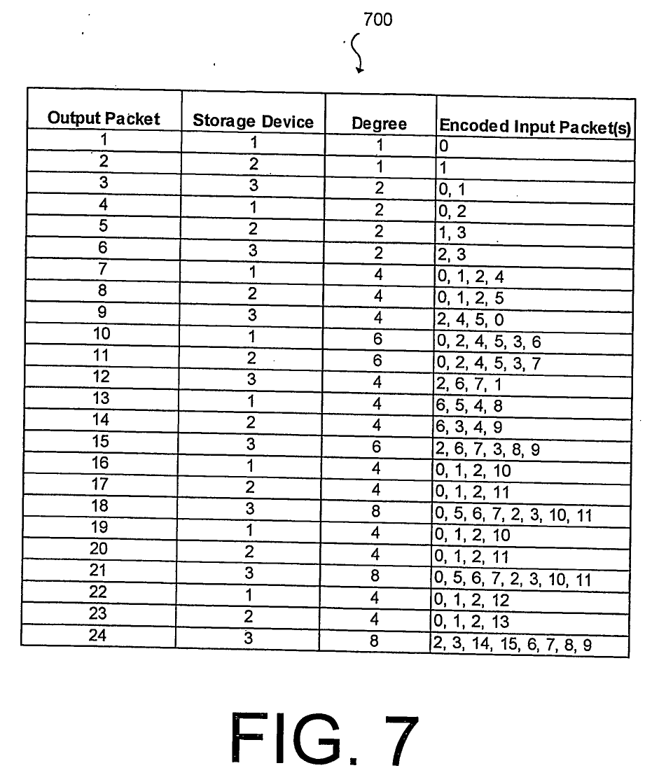

FIG. 7 is a chart 700 illustrating an exemplary user record divided into sixteen input packets 108, which are encoded into twenty-four output packets 110. Each output packet 110 is associated with a row. The column titled “Output Packet” identifies each individual output packet 110 by number. The column titled “Storage Device” displays the storage device 112 that will store the output packet 110. The example of FIG. 7 uses three storage devices 112. Each successive output packet 110 is stored to one of three storage devices 112 in a round-robin approach. The column titled “Degree” identifies the degree of the output packet 110 for each row. The final column titled “Encoded Input Packet(s)” displays each input packet 108 that will be encoded into the output packet 110 specific to that row. There are sixteen input packets 108 labeled 0-15. For example, output packet 7 is stored in the storage device 1 and has a degree of four. The four input packets 108 that will be encoded into output packet 7 are input packets 0, 1, 2, 4. In this example it would be possible to lose one storage drive 112 and still recover all of the input packets 108 in order to reconstruct the user record 102. As can be seen from the chart in FIG. 7, if storage device 1 failed, the input packets 108 associated with the output packets 110 stored in storage device 1 can be recovered using the other output packets 110 stored in storage devices 2 and 3.

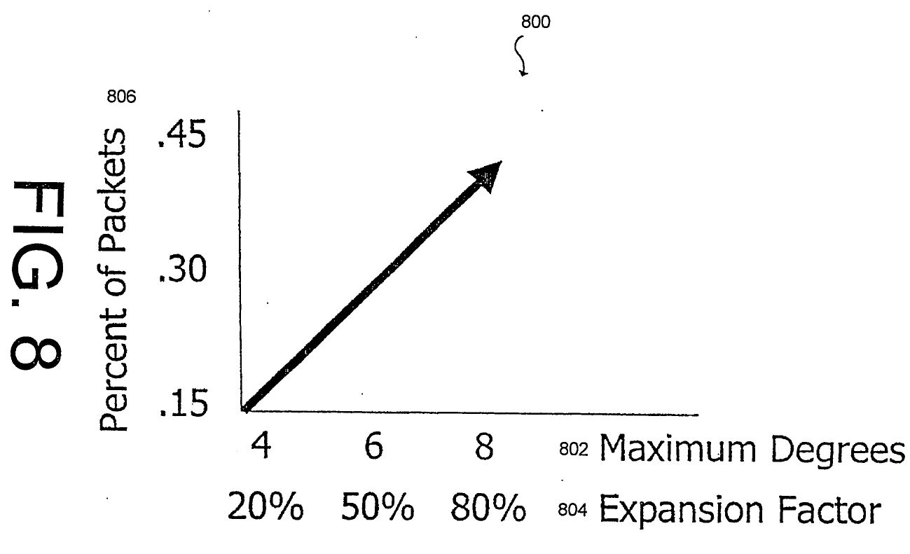

The shape of the degree function and the expansion factor can control the balance between data recovery, processing time, and management of system resources. FIG. 8 is a graph 800 illustrating the impact of the degree of the output packet 802 and the expansion factor 804 on the percentage of packets 806 that can be lost without affecting recovery of a user record 102. To distribute the data, the system 100 determines where to store each of the output packets 110. Each user record 102 is mapped to a storage group. As part of set-up, each storage device 112 known to the system is grouped with other storage devices that are independent of one another; that is, a failure of one has no effect on another.

The system 100 can also take into account many other factors. For example, the system 100 can concurrently monitor the performance of each networked storage device 112 (including the transmission path) and the amount of storage available on the storage device 112 to create a ranking (“R”) of the current performance of the storage device 112. This ranking can be used to determine which of the storage devices 112 are used to store each output packet 110. Each new write performed by the system 100 can be addressed to the storage device 112 with the highest current response time value “R”. This reduces the potential of slow storage devices 112 to be a limiting factor for data retrieval.

The system 100 collects data about storage device 112 performance in order to manage the data, optimize data distribution, and optimize device performance. Preferably, performance data on all operations is collected with both short- and long-term read and write performance taken into account for future storage operations. The system 100 can also monitor and recognize other changes to the environment, for example but not limited to, a storage device 112 networked to the system 100 going on-line or off-line, or the ranking of potential to lose output packets 110 by each storage device 112.

To enhance performance management, the system 100 collects storage environment performance data as a normal course of operation. As described above, this information is useful for optimizing performance at read and write, and also for automatically moving output packets 110 to rebalance storage capacity utilization. For example, when each read operation is initiated to a storage device 112 (e.g., any device in the storage infrastructure), a timer is initialized. When the requested output packet 110 is received, the timer is stopped. Performance metrics obtained include operations per second, bytes per second, and latency (time before requested data is returned). This is stored as a data element in the performance record for that storage device 112. The performance record for each storage device 112 is periodically evaluated using any of a number of processes to determine performance. This may include, for example, a weighted average, average over a recent period, moving average, or any other method for judging changes in performance from periodic readings. The performance of each storage device 112 is periodically ranked against other storage devices 112. This ranking is used to determine the “R” factor. The performance data history is also available to read and analyze to track historical performance to alert the system 100 of storage devices 112 that are the slowest performers (i.e., any which perform below a user-defined threshold).

In one example, the system 100 can use the “R” factor to initiate an automatic rebalancing operation based on the performance data. If a storage device 112 returns requested data with latency beyond a user-defined threshold, the system 100 can perform a rebalancing operation. The system 100 determines other output packets 110 stored on the same storage device 112 and may move these output packets 110 off that storage device 112. The “R” factor of other storage devices 112 is used to select alternative storage devices 112 to move the output packets 110 to, while maintaining availability objectives. The output packets 110 can then be transferred from the slow storage device 112 to target storage devices 112 (rebalancing), and the metadata is updated with the new location of output packets 110 moved.

The system 100 can also use factors associated with the user record 102 being stored by the system 100. For example, but not limited to, a priority profile factor (“P”) can be associated with each user record 102. Each user record 102 can be assigned a different P factor, which can be determined empirically by the user or by other factors associated with the user record 102, for example but not limited to, the number of previous requests for the specific user record 102, destination from which the user record 102 was received, or other protocol information associated with the user record 102. The system 100 can take into account both the P factor and the R performance ranking or other ranking when determining how and where to store the output packets 110 associated with that particular user record 102. For example, the system 100 can assign the output packet 110 associated with a high-ranking P value to the top-performing storage device 112 (i.e., high-ranking R value). The next successive output packets 110 can be assigned to the storage device 112 with the same or higher-ranking R value.

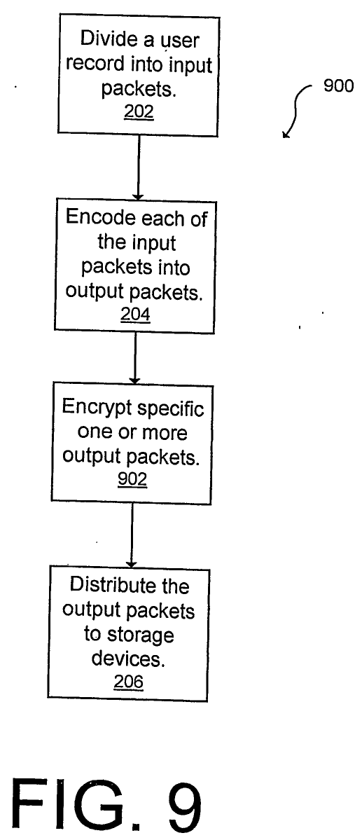

Encryption can also be incorporated into the method of storing data 200 of FIG. 2. As shown in FIG. 9, the method of storing data 900 also encrypts one or more of the output packets 110 (block 902). For example, any output packets 110 that are determined to have a degree of one (i.e., singletons) can be encrypted. In addition, the system 100 may specify that additional output packets 110, which meet certain other specified criteria, may also be encrypted. For example, output packets 110 that have a degree of two and contain an input packet 108 that is also a singleton in another output packet 110 may also so be encrypted to provide a greater degree of security. In the example shown in FIG. 3, output packets A and D are encrypted. In a system 100 that uses odd degrees of output packets 110 (for example, packets with a degree of 3, 5, or 7), the odd degree output packets 110 can be encrypted to provide similar security. The encryption may be performed using any suitable encryption algorithm, including Data Encryption Standard (DES), Triple Data Encryption Standard (3DES), Rivest's Cipher (RC4), and the like.

When encrypting singleton output packets 110, the encoding process creates “light encryption” suitable for masking the output packets 110 against unwanted intrusion in the storage network. This light encryption is created through three attributes of the process: dividing the user record 102 into input packets 108 reduces the ability to properly reassemble the user record 102 by reorganizing the data in storage, encoding transforms the data by combining the information in each input packet 108 that is encoded into the output packet 110, and only some output packets 110 are encrypted. As described above, typically singletons are encrypted to ensure complete security. To enhance security, other output packets 110 can also be encrypted.

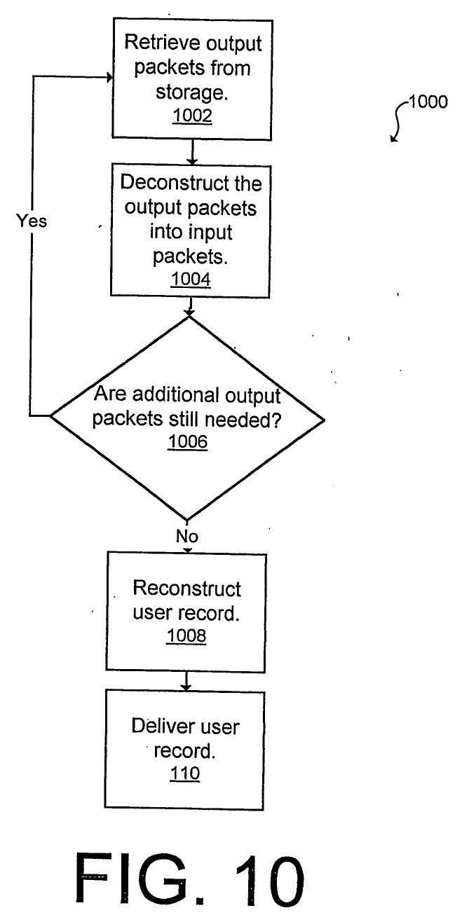

To retrieve the data, the system 100 can follow a wave method 1000 of requesting output packets as shown in FIG. 10. The system 100 retrieves the output packets 110 from the storage device 112 (block 1002). The system 100 may request the output packets 110 in successive waves, making sure that all of the input packets 108 can be restored, even if some of the output packets 110 are lost. The output packets 110 that were encrypted during the storing are decrypted. The output packets 110 are decoded to provide the input packets 108 housed within them (block 1004).

From the metadata or the output packets 110, the system 100 determines how each input packet 108 was encoded into its respective output packet 110 and how to combine input packets 108 into the desired user record 112. For example, once a singleton is obtained the system 100 determines which output packets 110 contain the decoded singleton, and decodes that singleton from every output packet 110 containing that singleton. As more output packets 110 are decoded, more input packets 108 can be identified from higher degree output packets 110. The process of decoding increases as more of the input packets 108 are decoded from the output packets 110. The system 100 evaluates whether all of the input packets 108 have been decoded to enable complete reconstruction of the user record 102 (block 1006). The decoded input packets 108 are used to reconstruct the user record 102 (block 1008).

If all of the input packets 108 have not been decoded, the system 100 evaluates which (if any) of the required input packets 108 are missing from the output packets 110 recovered and determines from the metadata which additional output packets 110 are needed (block 1006). The request and evaluation process is then repeated until all input packets 108 are recovered. Once all the necessary input packets 108 have been decoded and the user record 102 is reconstructed, the user record 102 is sent to the requesting device (block 1010).

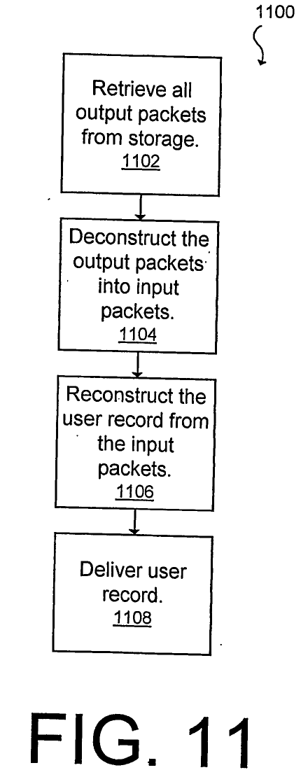

Alternatively, the process may perform a request all output packet method 1100 as shown in FIG. 11. The system 100 requests all output packets 110 stored (block 1102) and reconstructs the user record 102 once the minimum set of output packets 110 have been received. The output packets 110 are decoded to provide the input packets 108 housed within them (block 1104). The user record 102 is reconstructed from the input packets 108 (block 1106) and delivered (block 1108). The advantage of the wave method 1000 shown in FIG. 10 over the all output packet method 1100 shown in FIG. 11 is that the wave method eliminates unnecessary traffic to the storage devices 112, thus producing higher overall system performance.

The reconstruction process can also take advantage of the preference factors and user record 102 factors as discussed above. For example, the initial request can comprise the minimum set of output packets 110 from the storage devices 112 with the currently highest performance R values that can recover each input packet 108. The set of output packets 110 to request is obtained from the metadata. If one or more of the output packets 110 can not be read, successive “waves” of disk reads occur for the missing output packets 110 from the next highest performing storage device 112 containing the required output packets 110 until all data is recovered.

The reconstruction process can use the priority profile factor (“P”) associated with a user record 102 request. For example, the system 100 with a request for a lower ranking P may request the associated output packets 110 from storage devices 112 that are not currently under high demand or have a lower R performance ranking. This method of reconstruction allows the system 100 to keep specific resources available for requests for user records 102 that have a higher P ranking.

Architecturally, the system 100 can be located either on a stand-alone device such as a general purpose computer, for example a personal computer (PC; IBM-compatible, Apple-compatible, or otherwise), workstation, minicomputer, or mainframe computer. The system 100 can also be incorporated into other devices such as a Host Bus Adapter (HBA), a Storage Area Network (SAN) switch, Network Attached Storage (NAS) Head, or within the host operating system. The system 100 can be implemented by software (e.g., firmware), hardware, or a combination thereof.

Generally, the general purpose computer, in terms of hardware architecture, includes a processor, memory, and one or more input and/or output (I/O) devices (or peripherals) that are communicatively coupled via a local interface. The local interface can be, for example but not limited to, one or more buses or other wired or wireless connections, as is known in the art. The local interface may have additional elements, which are omitted for simplicity, such as controllers, buffers (caches), drivers, repeaters, and receivers, to enable communications. Further, the local interface may include address, control, and/or data connections to enable appropriate communications among the aforementioned components. It should be noted that the computer may also have an internal storage device therein. The internal storage device may be any nonvolatile memory element (e.g., ROM, hard drive, tape, CDROM, etc.) and may be utilized to store many of the items described above as being stored by the system 100.

The processor is a hardware device for executing the software, particularly that stored in memory. The processor can be any custom-made or commercially available processor, a central processing unit (CPU), an auxiliary processor among several processors associated with the storage system, a semiconductor-based microprocessor (in the form of a microchip or chip set), a macroprocessor, or generally any device for executing software instructions. Examples of suitable commercially available microprocessors are as follows: a PA-RISC series microprocessor from Hewlett-Packard Company, an 80×86 or Pentium series microprocessor from Intel Corporation, a PowerPC microprocessor from IBM, a Sparc microprocessor from Sun Microsystems, Inc, or an automated self-service series microprocessor from Motorola Corporation.

The memory can include any one or combination of volatile memory elements (e.g., random access memory (RAM, such as DRAM, SRAM, SDRAM, etc.)) and nonvolatile memory elements. Moreover, the memory may incorporate electronic, magnetic, optical, and/or other types of storage media. Note that the memory can have a distributed architecture, where various components are situated remote from one another, but can be accessed by the processor.

The software located in the memory may include one or more separate programs, each of which comprises an ordered listing of executable instructions for implementing logical functions. The software includes functionality performed by the system in accordance with the data storage distribution and retrieval system and may include a suitable operating system (O/S). A non-exhaustive list of suitable commercially available operating systems is as follows: (a) a Windows operating system available from Microsoft Corporation; (b) a Netware operating system available from Novell, Inc.; (c) a Macintosh operating system available from Apple Computer, Inc.; (d) a UNIX operating system, which is available for purchase from many vendors, such as the Hewlett-Packard Company, Sun Microsystems, Inc., and AT&T Corporation; (e) a LINUX operating system, which is freeware that is readily available on the Internet, or (f) a run time Vxworks operating system from WindRiver Systems, Inc. The operating system essentially controls the execution of the computer programs, such as the software stored within the memory, and provides scheduling, input-output control, file and data management, memory management, and communication control and related services.

The software is a source program, executable program (object code), script, or any other entity comprising a set of instructions to be performed. If the software is a source program, then the program needs to be translated via a compiler, assembler, interpreter, or the like, which may or may not be included within the memory, so as to operate properly in connection with the O/S. Furthermore, the software can be written as (a) an object oriented programming language, which has classes of data and methods, or (b) a procedure programming language, which has routines, subroutines, and/or functions, for example but not limited to, C, C++, Pascal, Basic, Fortran, Cobol, Perl, Java, and Ada.

The I/O devices may include input devices, for example but not limited to, a keyboard, mouse, scanner, microphone, touchscreen, etc. Furthermore, the I/O devices may also include output devices, for example but not limited to, a printer, display, etc. Finally, the I/O devices may further include devices that communicate both inputs and outputs, for instance but not limited to, a modulator/demodulator (i.e. modem; for accessing another device, system, or network), a radio frequency (RF) or other transceiver, a telephonic interface, a bridge, a router, etc.

When the computer is in operation, the processor is configured to execute the software stored within the memory, to communicate data to and from the memory, and to generally control operations of data pursuant to the data storage distribution and retrieval system.

The data storage distribution and retrieval system permits storage environments to make use of mid-range storage devices to achieve the benefits claimed by current high-end storage devices. Higher fault tolerance and faster performance are achieved using an approach that is device independent. Accordingly, a storage network may retain these benefits while using any generic storage device 112. Typical storage devices 112 may be, but are not limited to, SAN, NAS, iSCSI (internet Small Computer Systems Interface), InfiniBand, Serial ATA, Fibre Channel and SCSI. The system does not require all of the devices to be of the same make or design, allowing users to “mix and match” to achieve a low cost design.

The system may be integrated within a heterogeneous storage environment. Each encoded output packet 110 is transformed to comply with the protocol and format specified by the transmission and storage environments to which the output packet 110 is addressed. Accordingly, the output packet 110 may be sent to any storage device 112 using standard protocols. This enables the system to be extended across heterogeneous storage devices 112. Moreover, the output packets 110 are suitable for transmission using any of the common transfer protocols. This enables the benefits to be extended across geographically dispersed environments that are connected with any common communication topology (e.g. Virtual Private Network (VPN), Wide Area Network (WAN) or Internet).

The system can integrate a user-friendly interface (not shown) for the system administrator. For example, the system interface may not expose the expansion factor variable to the system administrator. The system interface may have windows and ask user-friendly questions such as “How many disks do you want to be able to lose?” and “On a scale of 1 to 100, specify relative desired performance appropriately.” As performance and availability requirements increase, more disks will be utilized and the expansion factor derived from this will increase appropriately.

The system may also have more fully automated storage management features. For example, the system may automatically route data to the best performing storage device 112 based on previously entered user settings and monitored performance perimeters of the storage device 112. The system may also recommend changes to the encoding and distribution parameters or automatically adjust the parameters, controlling availability based on usage and performance. Furthermore, the system may automatically adjust to reflect changes in system performance; for example, the system may automatically move data from low-performing storage devices 112 to those with better performance, or increase the number of disks a partition is stored on, thus increasing performance.

It should be emphasized that the above-described examples and embodiments of the present invention are merely possible examples of implementations, merely set forth for a clear understanding of the principles of the invention. Many variations and modifications may be made to the above-described embodiments of the invention without departing substantially from the spirit and principles of the invention. All such modifications and variations are intended to be included herein within the scope of this disclosure and the present invention and protected by the following claims.

What is claimed is:

1. A method of storing data, the method comprising:
dividing up a user record into a plurality of input packets;
encoding each of the plurality of input packets into more than one of a plurality of output packets; and
distributing the one or more output packets to a storage device.

2. The method of claim 1, wherein distributing involves distributing the one or more output packets to a plurality of storage devices.

3. The method of claim 1, wherein the location of the plurality of output packets is stored in a metadata.

4. The method of claim 1, wherein distributing includes striping that allows the user data to be reconstructed, without waiting for the last stored packet to be retrieved.

5. The method of claim 1, wherein distributing includes factoring storage device performance into the distribution of the plurality of output packets.

6. The method of claim 1 comprising encrypting one or more of the plurality of output packets to achieve the benefit of encryption.

7. A method of reconstructing a record, the method comprising:
a. retrieving a plurality of output packets from one or more storage devices;
b. deconstructing one or more of the one or more output packets into one or more input packets;
c. evaluating which output packets are needed to complete the user record; and
d. repeating steps a-c until a record is reconstructed.

8. The method of claim 7, wherein evaluating which output packets are needed involves evaluating which input packets are missing.

9. The method of claim 7, comprising decrypting one or more of the plurality of output packets.

10. The method of claim 7, wherein one or more singleton output packets are retrieved first.

11. The method of claim 7, wherein an output packet encoded with a plurality of input packets is retrieved first.

12. The method of claim 7, further comprising accessing metadata to determine the location of one or more of the plurality of output packets.

13. The method of claim 7, further comprising factoring device performance into determining which output packets to retrieve.

14. A computer-readable media tangibly embodying a program of instructions executable by a computer to perform a method of storing data, the method comprising:
dividing up a user record into a plurality of input packets;
encoding each of the plurality of input packets into more than one of a plurality of output packets; and
distributing the one or more output packets to a storage device.

15. The computer-readable media of claim 14, wherein distributing involves distributing the one or more output packets to a plurality of storage devices.

16. The computer-readable media of claim 14, wherein the location of the plurality of output packets is stored in a metadata.

17. The computer-readable media of claim 14, wherein the distributing includes striping that allows the user data to be reconstructed, without waiting for the last stored packet to be retrieved.

18. The computer-readable media of claim 14, wherein the distributing includes factoring storage device performance into the distribution of the plurality of output packets.

19. The computer-readable media of claim 14, comprising encrypting one or more of the plurality of output packets to achieve the benefit of encryption.

20. A device for storing data, the device comprising:
a module to divide up a user record into a plurality of input packets;
a module to encode each of the plurality of input packets into more than one of a plurality of output packets; and
a module to distribute the one or more output packets to a storage device.

21. The device of claim 20, wherein the module to distribute involves distributing the one or more output packets to a plurality of storage devices.

22. The device of claim 20, wherein the location of the plurality of output packets is stored in a metadata.

23. The device of claim 20, wherein the module to distribute includes a module to stripe that allows the user data to be reconstructed, without waiting for the last stored packet to be retrieved.

24. The device of claim 20, wherein the module to distribute includes factoring storage device performance into the distribution of the plurality of output packets.

25. The device of claim 20, comprising a module to encrypt one or more of the plurality of output packets to achieve the benefit of encryption.
